(19) United States
(12) Patent Application Publication
(10) Pub. No.: US 2006/0184735 A1
(43) Pub. Date: Aug. 17, 2006

(54) Methodology for effectively utilizing processor cache in an electronic system

(75) Inventor: Robert A. Hillman, San Diego, CA (US)

Correspondence Address: Maxwell Technologies, Inc.;Att. Intellectual Property Dept., 9244 Balboa Ave., San Diego, CA, 92123, US

(73) Assignee: Maxwell Technologies, Inc.

(21) Appl. No.: 11/058,468

(22) Filed: Feb. 15, 2005

(51) Int. Cl. G06F 12/00; G06F 13/28

(52) U.S. Cl. 711/118; 711/146

(57) ABSTRACT

A system and method for efficiently performing processing operations includes a processor configured to control processing operations in an electronic apparatus, and a memory coupled to the electronic apparatus for storing electronic information. A cache is provided for locally storing cache data copied by the processor from target data in the memory. The processor typically modifies the cache data stored in the cache. When an external device initiates a read operation to access the target data, the processor responsively updates the target data with the cache data. In addition, the processor utilizes cache-data retention procedures to retain the cache data locally in the cache to facilitate subsequent processing operations.

### BACKGROUND SECTION

1. Field of Invention

This invention relates generally to techniques for effectively implementing electronic systems, and relates more particularly to a methodology for effectively utilizing processor cache in an electronic system.

2. Description of the Background Art

Developing techniques for effectively implementing electronic systems is a significant consideration for designers and manufacturers of contemporary electronic systems. However, effectively implementing electronic systems may create substantial challenges for system designers. For example, enhanced demands for increased system functionality and performance may require more system processing power and require additional hardware resources. An increase in processing or hardware requirements may also result in a corresponding detrimental economic impact due to increased production costs and operational inefficiencies.

Furthermore, enhanced system capability to perform various advanced operations may provide additional benefits to a system user, but may also place increased demands on the control and management of various system components. For example, an electronic system that communicates with other external devices over a distributed electronic network may benefit from an effective implementation because of the bi-directional communications involved, and the complexity of may electronic networks.

Due to growing demands on system resources, substantially increased data magnitudes, and certain demanding operating environments, it is apparent that developing new techniques for effectively implementing electronic systems is a matter of concern for related electronic technologies. Therefore, for all the foregoing reasons, developing effective techniques for implementing and utilizing electronic systems remains a significant consideration for designers, manufacturers, and users of contemporary electronic systems.

### SUMMARY

In accordance with the present invention, a methodology is disclosed for effectively utilizing processor cache coupled to a processor in an electronic system. In accordance with one embodiment of the present invention, an external device initially generates a read request to a controller of the electronic system for accessing target data from a memory coupled to the electronic system. The controller then detects the read request from the external device on an 1/0 bus coupled to the controller.

In response, a master module of the controller broadcasts an address-only snoop signal to the processor of the electronic system via a processor bus. Next, the electronic system determines whether a snoop hit occurs as a result of broadcasting the foregoing address-only snoop signal. A snoop hit may be defined as a condition in which cache data copied from the memory of the electronic system has been subsequently modified so that the local cache data in the processor cache is no longer the same as the original corresponding data in the memory.

If a snoop hit does not occur, then the controller may immediately access the original target data from memory, and may provide the original target data to the external device to thereby complete the requested read operation. However, if a snoop hit does occur, then the processor objects by utilizing any appropriate techniques. The processor next flushes the cache version (cache data) of the requested target data to memory to replace the original version of the requested target data.

In accordance with the present invention, the processor advantageously retains the flushed cache data locally in the cache for convenient and rapid access during subsequent processing operations. The controller may perform a confirmation snoop procedure over processor bus to ensure that the most current version of the requested target data has been copied from the cache to memory.

The controller may then access the updated target data from memory. Finally, the controller may provide the requested target data to the external device to thereby complete the requested read operation. For at least the foregoing reasons, the present invention therefore provides an improved methodology for effectively utilizing processor cache in an electronic system.

### BRIEF DESCRIPTION OF THE DRAWINGS

FIG. 1 is a block diagram of an electronic system, in accordance with one embodiment of the present invention;

FIG. 2 is a block diagram for one embodiment of the processor module of FIG. 1, in accordance with the present invention;

FIG. 3 is a block diagram for one embodiment of the controller of FIG. 1, in accordance with the present invention;

FIG. 4 is a block diagram for one embodiment of the memory of FIG. 1, in accordance with the present invention;

FIG. 5 is a block diagram illustrating data caching techniques, in accordance with the present invention; and

FIGS. 6A and 6B are a flowchart of method steps for effectively utilizing processor cache, in accordance with one embodiment of the present invention.

### DETAILED DESCRIPTION

The present invention relates to an improvement in implementing electronic systems. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention is described herein as a system and method for efficiently performing processing operations, and includes a processor configured to control processing operations in an electronic apparatus, and a memory coupled to the electronic apparatus for storing-electronic information. A cache is provided for locally storing cache data copied by the processor from target data in the memory. The processor typically modifies the cache data stored in the cache. When an external device initiates a read operation to access the target data, the processor responsively updates the target data with the cache data. In addition, the processor utilizes cache-data retention procedures to retain the cache data locally in the cache to facilitate subsequent processing operations.

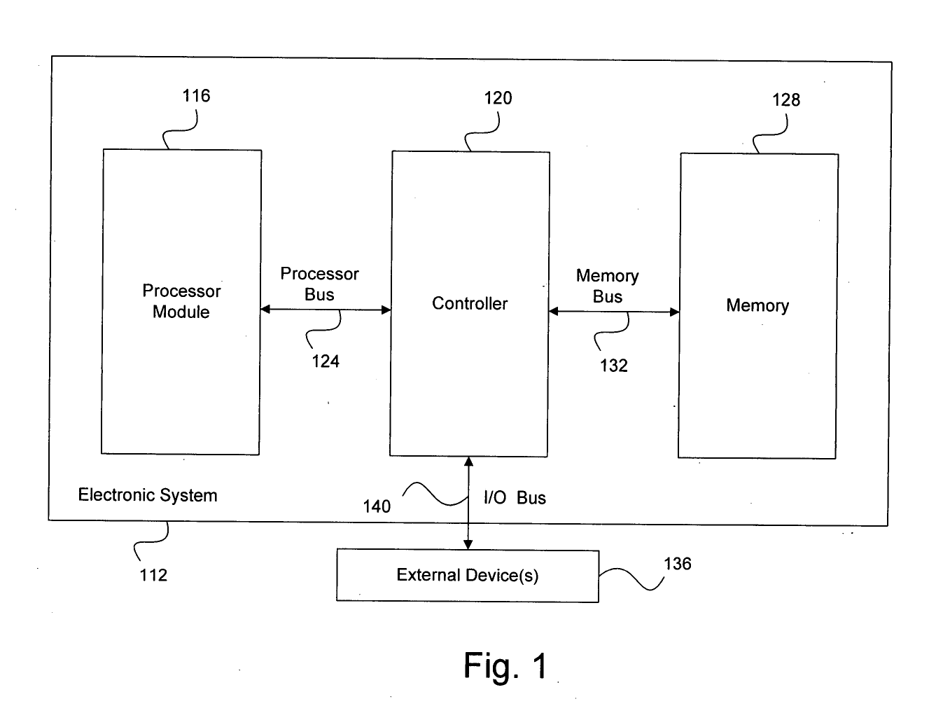

Referring now to FIG. 1, a block diagram of an electronic system 112 is shown, in accordance with one embodiment of the present invention. In the FIG. 1 embodiment, electronic system 112 may include, but is not limited to, a processor module 116, a controller 120, and memory 128. In alternate embodiments, electronic system 112 may be implemented using components and configurations in addition to, or instead of, certain of those components and configurations discussed in conjunction with the FIG. 1 embodiment.

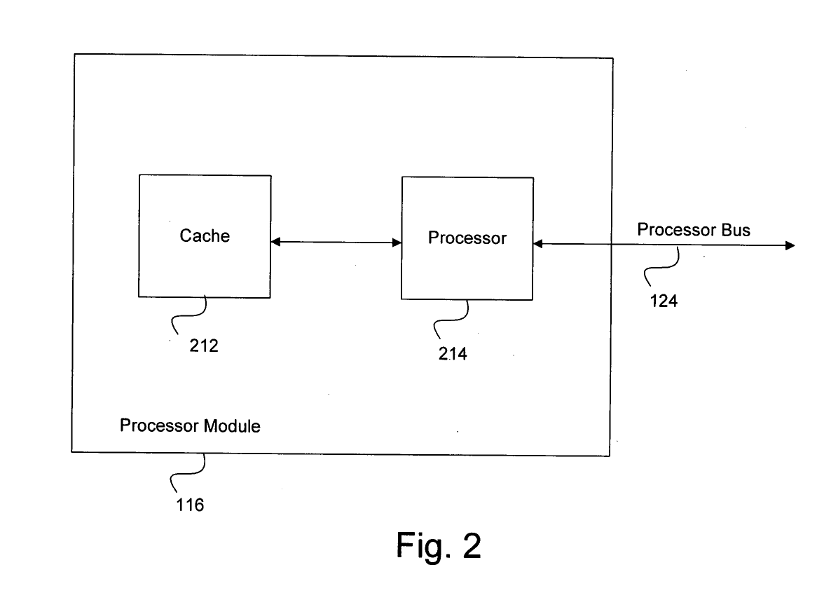

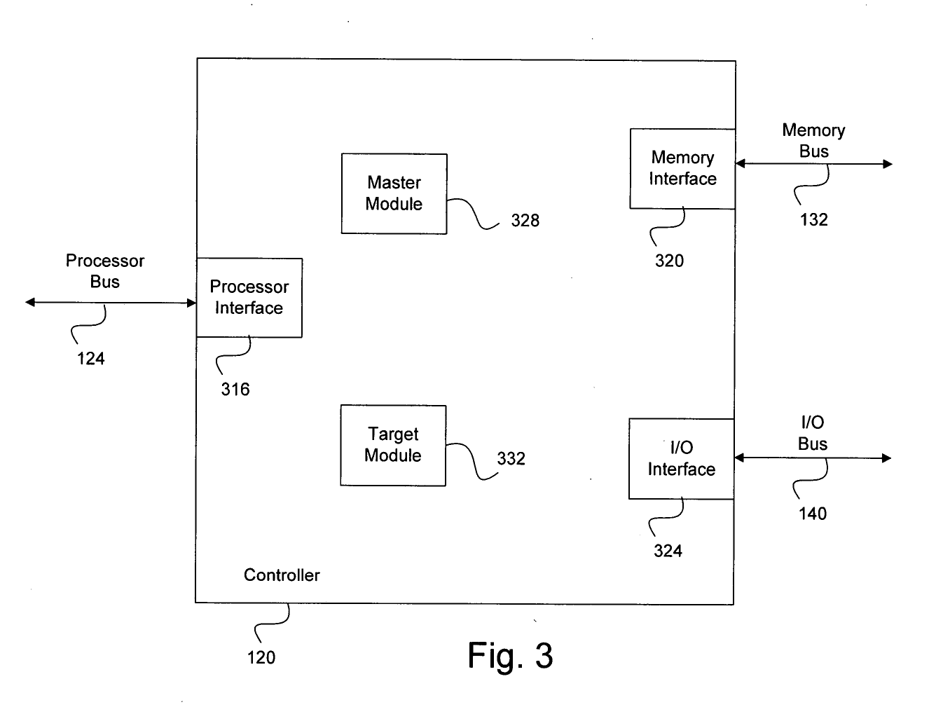

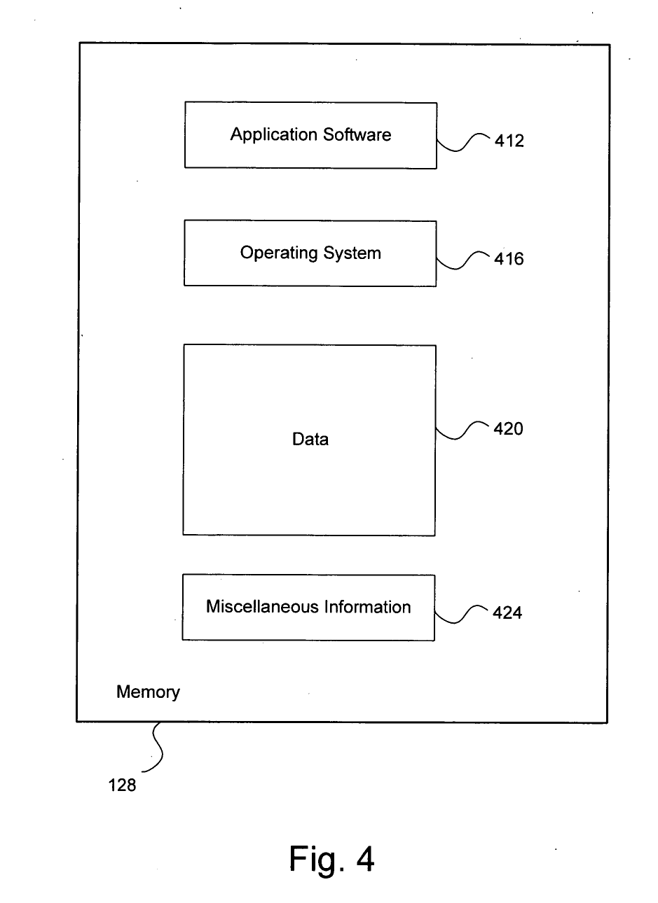

In the FIG. 1 embodiment, processor module 116 may be implemented to include any appropriate and compatible processor device(s) that execute software instructions for controlling and managing the operation of electronic system 112. Processor module 116 is further discussed below in conjunction with FIG. 2. In the FIG. 1 embodiment, electronic system 112 may utilize controller 120 for bi-directionally coordinating communications both for processor module 116 over processor bus 124 and for memory 128 over memory bus 132. Electronic system 112 may also utilize controller 120 to communicate with one or more external devices 136 via input/output (I/O) bus 140. Controller 120 is further discussed below in conjunction with FIG. 3. In the FIG. 1 embodiment, memory 128 may be implemented to include any combination of desired storage devices, including, but not limited to, read-only memory (ROM), random-access memory (RAM), and various other types of volatile and non-volatile memory. Memory 128 is further discussed below in conjunction with FIG. 4.

Referring now to FIG. 2, a block diagram for one embodiment of the FIG. 1 processor module 116 is shown, in accordance with the present invention. In the FIG. 2 embodiment, processor module 116 may include, but is not limited to, a processor 214 and a cache 212. In alternate embodiments, processor module 116 may readily be implemented using components and configurations in addition to, or instead of, certain of those components and configurations discussed in conjunction with the FIG. 2 embodiment.

In the FIG. 2 embodiment, processor 214 typically accesses a copy of required data from memory 128 (FIG. 1), and stores the accessed data locally in cache 212 for more rapid and convenient access. In order to maintain optimal performance of processor module 116, it is important to keep relevant data locally in cache 212 whenever possible. If given data is stored in the processor cache, that cache data in cache 212 is assumed to be more current than the corresponding data stored in memory 128 (FIG. 1) because processor 214 may have modified the cache data in cache 212 after reading the original data from memory 128.

Therefore, if an external device 136 wants to read target data from memory 129, in order to read the most current version of the target data, the external device 136 initially requests processor 214 for permission to read the target data from memory 128 through a snoop procedure or other appropriate techniques. If processor 128 has previously transferred a copy of the target data from memory 128 to cache 212, then the external device 128 preferably waits until the cache version of the target data is flushed back to memory 128 before controller 120 (FIG. 1) provides the updated target data from memory 128 to the requesting external device 136.

In conventional systems, when a processor flushes cache data out of processor cache in response to a read request, the processor then invalidates, deletes, or otherwise discards the flushed cache data from the processor cache. However, in accordance with the FIG. 2 embodiment of the present invention, after processor 214 flushes cache data to memory 128 in response to a read request from an external device 136, processor 214 then advantageously retains the flushed cache data in cache 212 by utilizing appropriate cache-data retention techniques, thus speeding up the next accesses by processor 214 to the particular flushed cached data by increasing the likelihood of successful cache hits.

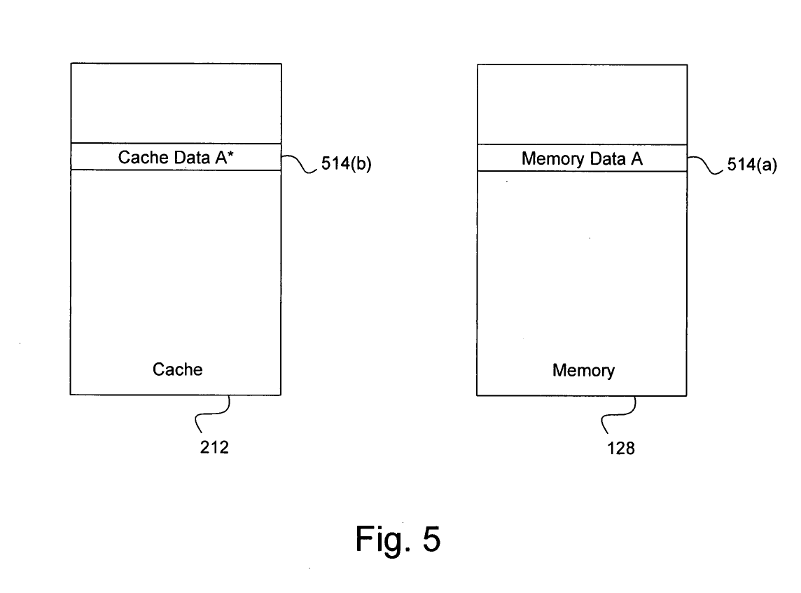

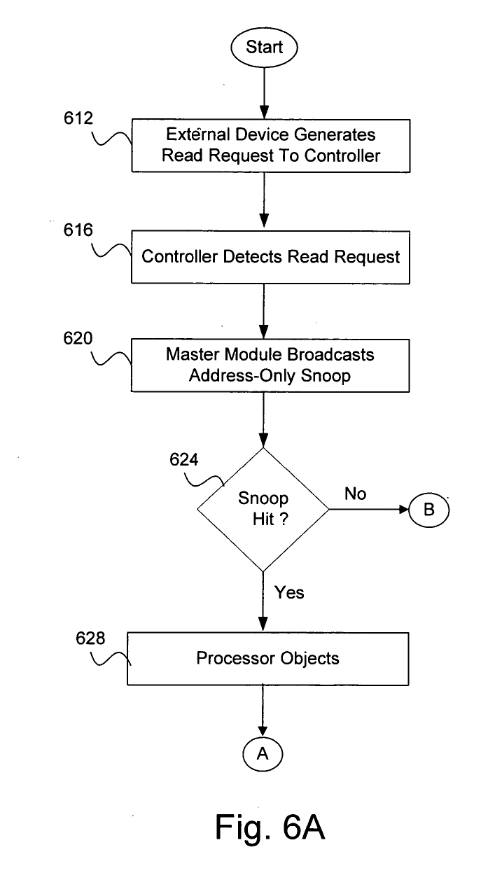

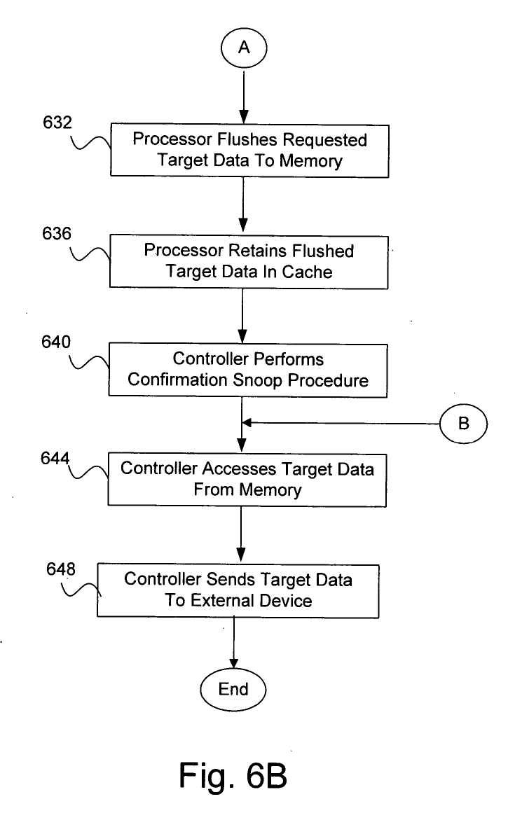

In the FIG. 2 embodiment, the present invention may utilize a special address-only snoop signal that is broadcast to processor 214 by controller 120 (FIG. 1) in response to the read request from the external device 136. In certain embodiments, the foregoing address-only snoop signal may include an address-only RWNIC (read-with-no-intent-to-cache) signal. In response to the address-only snoop signal, electronic system 112 advantageously supports a bus protocol for processor bus 124 and processor module 116 that allows processor 214 to flush a cache version of requested target data from cache 212 to memory 128, while concurrently utilizing cache-data retention techniques to retain the flushed cache data locally in cache 212. The operation of processor module 116 is further discussed below in conjunction with FIGS. 5 and 6.

Referring now to FIG. 3, a block diagram for one embodiment of the FIG. 1 controller 120 is shown, in accordance with the present invention. In the FIG. 3 embodiment, controller 120 includes, but is not limited to, a processor interface 316, a memory interface 320, an input/output (I/O) interface 324, a master module 328, and a target module 332. In alternate embodiments, controller 120 may readily include other components in addition to, or instead of, certain of those components discussed in conjunction with the FIG. 3 embodiment.

In the FIG. 3 embodiment, controller 120 may receive a read request on I/O bus 140 from an external device 136 (FIG. 1) to read target data from a memory 128 (FIG. 1) of an electronic system, 112. In response, master module 328 may broadcast an address-only snoop signal to processor 214 (FIG. 1) via processor bus 124. In certain embodiments, the foregoing address-only snoop signal may include an address-only RWNIC (read with no intent to cache) signal that corresponds to an address phase but does not include a corresponding data phase.

In response to the address-only snoop signal, controller 120 advantageously supports a bus protocol for processor bus 124 and processor module 116 that allows processor 214 to flush a cache version of requested target data from cache 212 (FIG. 2) into memory 128 while concurrently utilizing cache-data retention techniques to retain the flushed cache data locally in cache 212. In the FIG. 3 embodiment, target module 332 may be configured to support the foregoing address-only snoop signal and cache-data retention techniques by not performing any type of data phase for transferring data associated with the address-only snoop cycle. The utilization of controller 120 is further discussed below in conjunction with FIGS. 5 and 6.

Referring now to FIG. 4, a block diagram for one embodiment of the FIG. 1 memory 128 is shown, in accordance with the present invention. In the FIG. 4 embodiment, memory 128 includes, but is not limited to, application software 412, an operating system 416, data 420, and miscellaneous information 424. In alternate embodiments, memory 128 may readily include other components in addition to, or instead of, certain of those components discussed in conjunction with the FIG. 4 embodiment.

In the FIG. 4 embodiment, application software 412 may include program instructions that are executed by processor module 116 (FIG. 1) to perform various functions and operations for electronic system 112. The particular nature and functionality of application software 412 typically varies depending upon factors such as the specific type and particular functionality of the corresponding electronic system 112. In the FIG. 4 embodiment, operating system 416 may be implemented to effectively control and coordinate low-level functionality of electronic system 112.

In the FIG. 4 embodiment, data 420 may include any type of information, data, or program instructions for utilization by electronic system 112. For example, data 420 may include various types of target data that one or more external devices 136 may request to access from memory 128 during a read operation. In the FIG. 4 embodiment, miscellaneous information 424 may include any appropriate type of ancillary data or other information for utilization by electronic system 112. The utilization of memory 120 is further discussed below in conjunction with FIGS. 5 and 6.

Referring now to FIG. 5, a block diagram illustrating data caching techniques is shown, in accordance with one embodiment of the present invention. The FIG. 5 example is presented for purposes of illustration, and in alternate embodiments, data caching techniques may readily be performed using techniques and configurations in addition to, or instead of, certain those techniques and configurations discussed in conjunction with the FIG. 5 embodiment.

In the FIG. 5 example, memory 128 includes memory data A 514(a) that is stored at a corresponding memory address A of memory 128. Under certain circumstances, a processor 214 (FIG. 1) may transfer a copy of memory data A 514(a) to a local processor cache 212 as cache data A* 514(b) for convenient and more rapid access when performing processing functions. While stored in cache 212, processor 214 may typically modify or alter cache data A* 514(b) to become different from the original version of memory data A 514(a) that is stored in memory 128.

Meanwhile, in certain instances, an external device 136 (FIG. 1) may seek to access memory data A 514(a) from memory 128 as target data in a read operation. In order to provide the most current version of the requested target data, processor 214 may flush cache data A* 514(b) back to memory 128 to overwrite memory data A 514(a) at memory address A with cache data A* 514(b).

In convention systems, processor 214 then typically deletes cache data A* 514(b) from cache 212. However, if cache data A* 514(b) is deleted, then the next time that processor 214 seeks to perform an operation to or from cache data A* 514(b), processor 214 must perform a time-consuming and burdensome read operation to return memory data A 514(a) from memory 128 to cache 212 as cache data A* 514(b). As discussed above, electronic system 112 therefore advantageously supports a bus protocol for processor bus 124 and processor module 116 that allows processor 214 to flush cache data A* 514(b) from cache 212 into memory 128, while concurrently utilizing cache-data retention techniques to retain cache data A* 514(b) locally in cache 212, in response to the foregoing address-only snoop signal. The data caching techniques illustrated above in conjunction with FIG. 5 are further discussed below in conjunction with FIG. 6.

Referring now to FIGS. 6A and 6B, a flowchart of method steps for effectively utilizing processor cache 212 is shown, in accordance with one embodiment of the present invention. The FIG. 6 example (FIGS. 6A and 6B) is presented for purposes of illustration, and in alternate embodiments, the present invention may readily utilize steps and sequences other than certain of those steps and sequences discussed in conjunction with the embodiment of FIG. 6.

In the FIG. 6A embodiment, in step 612, an external device 136 initially generates a read request to a controller 120 of an electronic system 1 12 for accessing target data from a memory 128. In step 616, controller 120 detects the read request on an I/O bus 140. In response, a master module 328 of controller 120 broadcasts an address-only snoop signal to a processor module 116 of the electronic system 112 via a processor bus 124. In step 624, electronic system 112 determines whether a snoop hit occurs as a result of broadcasting the foregoing address-only snoop signal. A snoop hit may be defined as a condition in which cache data copied from memory 128 has been subsequently modified so that the local cache data in cache 212 is no longer the same as the original corresponding data in memory 128.

In step 624, if a snoop hit occurs, then the FIG. 6A process advances to step 628. However, if a snoop hit does not occur in step 624, then the FIG. 6A process advances to step 644 of FIG. 6B via connecting letter “B”. In step 628, if a snoop hit has occurred, then processor 214 objects by utilizing any appropriate techniques. The FIG. 6A process then advances to step 632 of FIG. 6B via connecting letter “A”.

In step 632, processor 214 flushes the cache version (cache data) of the requested target data to memory 128 to replace the original version of the requested target data. In certain alternate embodiments, the target data may be intercepted and provided directly to the requesting external device 136 instead of first storing the target data into memory 128.

In accordance with the present invention, in step 636, processor 214 advantageously retains the flushed cache data locally in cache 212 for convenient and rapid access during subsequent processing operations. In step 640, controller 120 may perform a confirmation snoop procedure over processor bus 124 to ensure that the most current version of the requested target data has been copied from cache 212 to memory 128.

In step 644, controller 120 may then access the updated target data from memory 128. Finally, in step 648, controller 120 may provide the requested target data to external device 136 to thereby complete the requested read operation. The FIG. 6 process may then terminate. For at least the foregoing reasons, the present invention therefore provides an improved methodology for effectively utilizing processor cache 212 in an electronic system 112.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for efficiently performing processing operations, comprising:
a processor configured to control said processing operations in an electronic apparatus;
a memory coupled to said electronic apparatus for storing electronic information;
a cache for locally storing cache data copied by said processor from target data in said memory, said processor subsequently modifying said cache data;
an external device that initiates a read operation to access said target data, said processor responsively updating said target data with said cache data, said processor retaining said cache data locally in said cache to facilitate subsequent ones of said processing operations.

2. The system of claim 1 wherein said cache is implemented as processor cache locally coupled to said processor for storing selected data originally copied from said memory of said electronic apparatus, said processor cache facilitating rapid and convenient access to said selected data by said processor.

3. The system of claim 1 wherein said electronic apparatus is implemented as a computer device that is coupled to a distributed electronic network which includes said external device.

4. The system of claim 1 wherein said processor initially copies said target data from said memory into said cache as said cache data, said processor then utilizing said cache data to perform at least one of said processing operations, said processor altering said cache data with respect to said target data during said at least one of said processing operations.

5. The system of claim 1 wherein said processor and said memory bi-directionally communicate through a controller, said controller also coordinating bi-directional communications between said external entity and either said processor or said memory of said electronic apparatus.

6. The system of claim 1 wherein said external entity initiates said read operation by transmitting a read request to a controller of said electronic apparatus for requesting permission to access said target data from said memory.

7. The system of claim 6 wherein said controller of said electronic apparatus detects said read request from said external device on an input/output bus coupling said external device to said controller.

8. The system of claim 6 wherein a master module of said controller broadcasts an address-only snoop signal over a processor bus to said processor in response to said read request from said external device.

9. The system of claim 8 wherein said address-only snoop signal includes an address-only read-with-no-intent-to-cache signal.

10. The system of claim 8 wherein said electronic apparatus determines whether a snoop hit is detected in response to said address-only snoop signal being broadcast over said processor bus by said master module of said controller.

11. The system of claim 10 wherein said snoop hit indicates that said processor has modified said cache data since said cache data was copied from said target data originally stored in said memory.

12. The system of claim 10 wherein said controller transfers said target data from said memory to said external device whenever no snoop hit occurs.

13. The system of claim 10 wherein said processor objects whenever a snoop hit occurs after said address-only snoop signal is broadcast from said master module of said controller.

14. The system of claim 10 wherein said processor updates said target data with said cache data whenever a snoop hit occurs.

15. The system of claim 14 wherein said processor utilizes cache-data retention techniques to retain said cache data locally in said cache after said cache data is flushed back to said memory for updating said target data.

16. The system of claim 15 wherein a cache-data retention bus protocol supports said cache-data retention techniques in response to said address-only snoop signal.

17. The system of claim 15 wherein a target module of said controller performs no data phase in response to said address-only snoop signal.

18. The system of claim 15 wherein said electronic apparatus performs a snoop confirmation procedure to confirm that said target data in said memory has been updated with said cache data.

19. The system of claim 15 wherein said controller accesses and sends said target data from said memory to said external device after said target data has been updated with said cache data.

20. The system of claim 1 wherein said processor is able to access said cache data locally in said cache after said target data is updated, without expending processing resources and without waiting through a transfer period required to read said target data back into said cache as said cache data.

21. A method for efficiently performing processing operations, comprising:
controlling said processing operations in an electronic apparatus by utilizing a processor;
storing electronic information in a memory coupled to said electronic apparatus;
storing cache data in a cache, said cache data being copied by said processor from target data in said memory, said processor subsequently modifying said cache data;
initiating a read operation for an external device to access said target data, said processor responsively updating said target data with said cache data, said processor retaining said cache data locally in said cache to facilitate subsequent ones of said processing operations.
